(19) United States
(12) Patent Application Publication
(10) Pub. No.: US 2007/0160207 A1
(43) Pub. Date: Jul. 12, 2007

(54) Method for matching a reception terminal with a plurality of access control cards

(76) Inventors: Frederic Beun, Chatou (FR); Laurence Boudier, Chatou (FR); Pierre Roque, Paris (FR); Bruno Tronel, Puteaux (FR)

Correspondence Address: ANDERSON, KILL & OLICK, P.C., 1251 AVENUE OF THE AMERICAS, NEW YORK,, NY, 10020-1182, US

(21) Appl. No.: 10/589,837

(22) PCT Filed: Feb. 17, 2005
(86) PCT No.: PCT/FR05/50101

§ 371 Date: Aug. 18, 2006

(30) Foreign Application Priority Data
Feb. 20, 2004 (FR) 0450323

(51) Int. Cl. H04N 7/167

(52) U.S. Cl. 380/210; 380/239; 380/229; 380/230; 380/241

(57) ABSTRACT

The invention related to a method for matching reception equipment (2) with a plurality of security modules (6, 8) each having a unique identifier. The method according to the invention comprises the following steps:
connecting a security module (6, 8) to the reception equipment (2),
memorising the unique identifier of the connected security module (6, 8) in the reception equipment (2), on the fly.

### TECHNICAL FIELD

The invention is in the field of security of broadcast digital data and reception equipment that will receive these data in a data and/or services distribution network and is more specifically related to a method for matching digital data reception equipment with a plurality of external security modules each with a unique identifier.

### STATE OF PRIOR ART

More and more operators are offering data and on-line services accessible from terminals provided with security processors. In general, distributed data and services are scrambled when being sent by using secret keys, and are descrambled on reception using the same secret keys previously provided to the subscriber.

Apart from classical access control techniques based on scrambling when sending and descrambling on reception of the distributed data, operators propose techniques based on matching of the reception terminal with a security processor to prevent the distributed data and services from being accessible to users who are using a stolen terminal or a pirated security processor for example such as a forged smart card.

Document WO 99 57901 describes a matching mechanism between a receiver and a security module based firstly on encryption and decryption of information exchanged between the receiver and the security module by a unique key stored in the receiver or in the security module, and secondly on the presence of a receiver number in the security module.

One disadvantage of this technique is due to the fact that the association between a receiver and a security module matched to it is set up in advance, and the operator cannot efficiently manage his collection of reception equipment to prevent this equipment being used improperly for fraudulent purposes.

One purpose of the matching method according to the invention is to enable each operator to limit use of his collection of reception equipment by configuring and dynamically controlling matching of the reception equipment and external security modules that will cooperate with this equipment.

### PRESENTATION OF THE INVENTION

The invention recommends a method for matching digital data reception equipment with a plurality of external security modules each with a unique identifier.

The method according to the invention comprises the following steps:
connecting an external security module to the reception equipment,
memorising the unique identifier of the connected security module in the reception equipment, on the fly.

This method includes a check phase that consists of verifying whether or not the identifier of said module is memorised in this reception equipment, every time that an external security module is connected to the reception equipment later on.

To achieve this, the method according to the invention also comprises a step of transmitting a signal to the reception equipment including at least one message to manage memorisation of the external security module identifier and/or a check phase management message.

Said signal includes at least one of the following instructions:
authorise memorisation,
prohibit memorisation,
erase identifiers previously memorised in the reception equipment,
activate or deactivating the check phase.

In a first variant embodiment of the method, the signal includes the maximum number of identifiers that are authorised to be stored.

In a second variant embodiment of the method, said signal includes a reconfiguration set value through which an updated list of identifiers of external security modules matched with said reception equipment is transmitted to the reception equipment.

Said list is transmitted either directly to the reception equipment, or through an external security module connected to said reception equipment.

Preferably, said check phase includes a procedure consisting of disturbing the data processing if the identifier of the connected external security module is not previously memorised in the reception equipment.

The method according to the invention is applicable when data are distributed without encryption and also when these data are distributed in scrambled form by an encrypted control word. In the latter case, each external security module includes access rights to said data and a decryption algorithm for said control word to descramble the data.

The control signal is transmitted in an EMM (Entitlement Management Message) specific to an external security module associated with this reception equipment or in an EMM message specific to this reception equipment, and for a given reception equipment, the updated list of identifiers of external security modules matched with this reception equipment is also transmitted in a specific EMM message to a security module associated with this reception equipment.

Alternately, said signal is transmitted in a private flow to a group of reception equipment and the updated list of external module identifiers is also transmitted in a private flow to each reception equipment. In the latter case, said private flow is processed by a dedicated software executable in each reception equipment as a function of the identifier of the external security module associated with it.

In another variant, the signal is transmitted to a group of reception equipment in an EMM message specific to a group of external security modules associated with said reception equipment or in an EMM message specific to said group of reception equipment, and for a given group of reception equipment, the updated list of identifiers of external modules is transmitted in an EMM message specific to a group of external security modules associated with said reception equipment.

Furthermore, for a given group of reception equipment, the control signals and the updated list may also be transmitted to a group of equipment in a private flow.

In this case, said private flow is processed by a dedicated software executable in each reception equipment as a function of the identifier of the external security module associated with it.

When the signal and updated lists have been transmitted by EMMs, the method includes a mechanism that prevents the use of an EMM transmitted to the same security module in two items of reception equipment.

EMMs specific to a security module or to a reception equipment are in the following format:

| | |
|---|---|
| EMM-U_section( ) { | |
| table_id = 0x88 | 8 bits |
| section_syntax_indicator = 0 | 1 bit |
| DVB_reserved | 1 bit |
| ISO_reserved | 2 bits |
| EMM-U_section_length | 12 bits |
| unique_adress_field | 40 bits |
| for (i=0; i<N; i++) { | |
| EMM_data_byte | 8 bits |
| } | |
| } | |

EMMs specific to all external security modules or to all reception equipment are in the following format:

| | |
|---|---|
| EMM-G_section( ) { | |
| table_id = 0x8A or 0x8B | 8 bits |
| section_syntax indicator = 0 | 1 bit |
| DVB_reserved | 1 bit |
| ISO_reserved 2 bits | |
| EMM-G_section_length | 12 bits |
| for (i=0; i<N; i++) { | |
| EMM_data_byte | 8 bits |
| } | |
| } | |

EMMs specific to a sub-group of external security modules or a sub-group of reception equipment are in the following format:

| | |
|---|---|
| EMM-S_section( ) { | |
| table_id = 0x8E | 8 bits |
| section_syntax_indicator = 0 | 1 bit |
| DVB_reserved | 1 bit |
| ISO_reserved | 2 bits |
| EMM-S_section length | 12 bits |
| shared_address_field | 24 bits |
| reserved | 6 bits |
| data_format | 1 bit |
| ADF_scrambling_flag | 1 bit |
| for (i=0; i<N; i++) { | |
| EMM_data_byte | 8 bits |

According to one additional characteristic, security modules identifiers are grouped in an encrypted list.

The method may be used in a first architecture in which the reception equipment includes a decoder and the security module includes an access control card in which information about access rights of a subscriber to digital data distributed by an operator is memorised.

In this architecture, matching is done between the decoder and the access control card.

The method may be used in a second architecture in which the reception equipment includes a decoder and the security module includes a removable security interface provided with a non-volatile memory that can cooperate firstly with the decoder, and secondly with a plurality of conditional access control cards to manage access to digital data distributed by an operator.

In this architecture, the matching is done between said decoder and said removable security interface.

The method may be used in a third architecture in which the reception equipment includes a decoder provided with a removable security interface with a non-volatile memory and that will cooperate firstly with said decoder and secondly with a plurality of conditional access control cards.

In this architecture, matching is done between said removable security interface and said access control cards.

In one particular application of the method according to the invention, the data are audiovisual programs.

The method according to the invention is used in a system including a plurality of reception equipment connected to a data and/or services broadcasting network, each reception equipment being matchable with a plurality of external security modules, this system also including a commercial management platform communicating with said reception equipment and with said external security modules. This system also includes:
a first module arranged in said commercial management platform and that will generate matching queries,
and a second security module arranged in said reception equipment that will process said queries to prepare a matching configuration and to control this matching.

The invention also relates to reception equipment that can be matched with a plurality of external security modules to manage access to digital data distributed by an operator.

According to the invention, this equipment includes means of memorising the identifier of each external security module connected to it, on the fly.

In a first embodiment, the reception equipment includes a decoder and the external security module is an access control card containing information about the access rights of a subscriber to said digital data, matching being done between said decoder and said card.

In a second embodiment, the equipment includes a decoder and the external security module is a removable security interface provided with a non-volatile memory that will cooperate firstly with said decoder and secondly with a plurality of conditional access control cards to manage access to said digital data, matching being done between said decoder and said removable security interface.

In a third embodiment, the equipment includes a decoder provided with a removable security interface with a non-volatile memory and that will cooperate firstly with said decoder and secondly with a plurality of conditional access control cards and matching is done between said removable security interface and said access control cards.

The invention also relates to a decoder that can cooperate with a plurality of external security modules to manage access to audiovisual programs distributed by an operator, each external security module having a unique identifier and comprising at least one data processing algorithm.

The decoder according to the invention includes means of memorising the identifier of each external security module connected to it on the fly.

In a first embodiment, said external security modules are access control cards in which information about access rights of a subscriber to digital data distributed by an operator are memorised.

In a second embodiment, said external security modules are removable security interfaces including a non-volatile memory and that will cooperate firstly with the decoder, and secondly with a plurality of conditional access control cards to manage access to digital data distributed by an operator.

The invention also relates to a removable security interface including a non-volatile memory and that will cooperate firstly with reception equipment and secondly with a plurality of conditional access control cards, to manage access to digital data distributed by an operator, each card having a unique identifier and comprising information about access rights of a subscriber to said digital data.

The interface according to the invention includes means of recording the identifier of each access control card in said non-volatile memory, on the fly.

In a first variant, this interface is a PCMCIA (Personal Computer Memory Card International Association) card including a digital data descrambling software.

In a second variant, this interface is a software module that can be executed either in the reception equipment or in the external security module.

The invention also relates to a computer program that can be executed in a reception equipment capable of cooperating with a plurality of external security modules each of which has a unique identifier and in which information about access rights of a subscriber to digital data distributed by an operator are stored.

This computer program includes instructions to memorise the identifier of each external security module connected to said reception equipment and instructions that will locally generate matching control parameters of the reception equipment with an external security module as a function of signal transmitted to said reception equipment by the operator, on the fly.

This computer program also includes instructions that will verify if the identifier of said external security module is memorised in the reception equipment, during each subsequent use of an external security module with the reception equipment.

### BRIEF DESCRIPTION OF THE DRAWINGS

Other characteristics and advantages of the invention will become clear from the following description given as a non-limitative example with reference to the appended figures in which:

FIG. 1 shows a first architecture for use of matching according to the invention,

FIG. 2 shows a second architecture for use of matching according to the invention,

FIG. 3 shows a third architecture for use of matching according to the invention,

FIG. 4 shows the structure of EMM messages for configuration and use of matching functions according to the invention,

FIG. 5 shows a status diagram of the matching function according to the invention,

FIG. 6 shows a flowchart illustrating a particular embodiment of matching according to the invention.

### DETAILED PRESENTATION OF PARTICULAR EMBODIMENTS

The invention will now be described within the framework of an application in which an operator broadcasting audiovisual programs uses the method according to the invention to limit use of his reception equipment to his own subscribers.

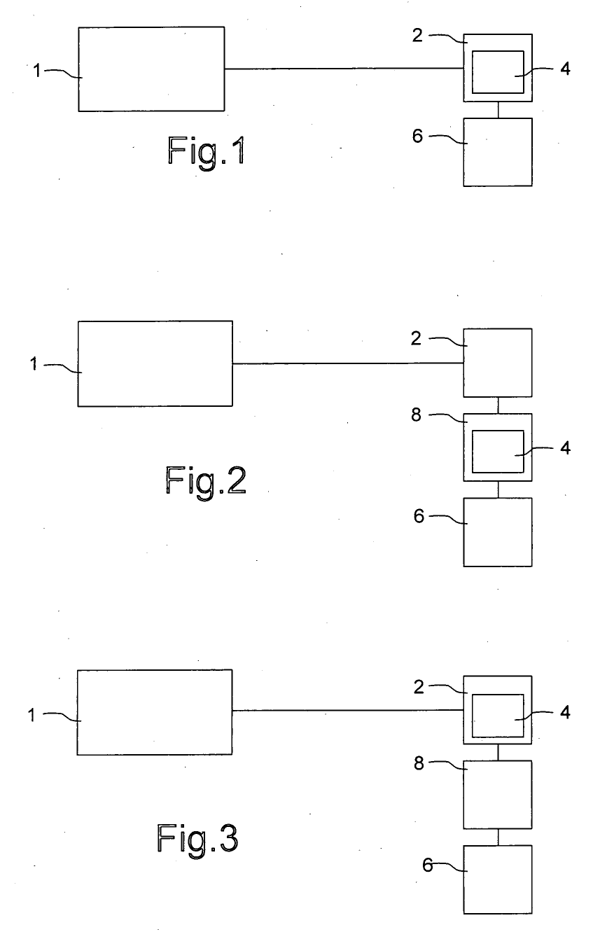

The method may be used in three distinct architectures shown in FIGS. 1, 2 and 3 respectively. Identical elements in these three architectures are denoted by identical references.

Management of matching is done from a commercial platform 1 controlled by the operator and communicating with reception equipment installed at the subscriber.

In the first architecture shown in FIG. 1, the reception equipment includes a decoder 2 in which an access control software 4 is installed, and the external security module is an access control card 6 containing information about access rights of a subscriber to broadcast audiovisual programs. In this case, matching is done between the decoder 2 and said card 6.

In the second architecture shown in FIG. 2, the reception equipment includes a decoder 2 not dedicated to access control, and the external security module is a removable security interface 8 provided with a non-volatile memory and in which the access control software 4 is installed. This interface 8 cooperates firstly with said decoder 2, and secondly with a card 6 among a plurality of conditional access control cards, to manage access to said audiovisual programs.

In this architecture, matching is done between said removal security interface 8 and said access control card 6.

In the third architecture shown in FIG. 3, the reception equipment includes a decoder 2 in which an access control software 4 is installed, this decoder 2 is connected to a removable security interface 8 with a non-volatile memory that cooperates with a card 6 among a plurality of conditional access control cards.

In this case, matching is done between the decoder 2 and the removable security interface 8.

The configuration and use of matching by the operator is the result of commands sent by the commercial management platform 1.

The following description relates to use of the invention in the case of matching of a decoder 2 with a card 6. The steps used are applicable to the three architectures described above.

All matching processing is inactive when a decoder 2 leaves the factory, and also after access control software 4 has been downloaded into this decoder. In particular:
no card identifier is memorised in the decoder 2,
the maximum number of memorisable card identifiers is not initialised,
memorisation of a card identifier 6 by the decoder 2 is not active,
control of a card identifier 6 by the decoder 2 is not active,

When a valid card is inserted in the card reader provided for this purpose in the decoder 2, matching between this card in the decoder 2 may then be configured by an operator query on the management platform 1 that sends an EMM management message dedicated to matching to the decoder 2. This EMM management message is addressed directly to the decoder 2 or indirectly through the card 6. This EMM management message performs the following tasks:
activating the matching function in the decoder 2; in this case, the decoder 2 verifies if the identifier of the card 6 forms part of the identifiers that it memorised. If not, and if the maximum number of memorisable card identifiers is not reached, the decoder memorises the identifier of this card,
deactivating the matching function in the decoder. In this case, the decoder does not check and does not memorise the card identifier 6,
erasing the card identifiers already stored in the decoder.
defining the maximum number of card identifiers that can be memorised by the decoder.

The operator can also send an EMM message through the platform 1 containing an imposed list of card identifiers 6 matched to a decoder 2. Such a message is addressed to the decoder 2 indirectly through the card 6.

Addressing of EMM Messages

EMM messages used for configuration and use of functions related to matching according to the method according to the invention are sent in an EMM channel of a digital multiplex as defined by the MPEG2/System standard and DVB/ETSI standards.

This channel can broadcast EMMs referencing a card address used to address them to:
the decoder into which a particular card is inserted,
decoders into which cards in a particular group are inserted,
decoders into which all cards are inserted.

These EMMs for use in decoders “through the card” are used particularly when decoders do not have an address.

This channel can also broadcast EMMs referencing a decoder address so that they can be addressed directly to:
a particular decoder,
a particular group of decoders,
all decoders;

EMMs that are intended for all decoders can also be used when the decoders do not have an address.

Messages intended for a decoder designated by a particular card or directly for a particular decoder are EMM-U messages with the following structure:

| | |
|---|---|
| EMM-U_section( ){ | |
| table_id = 0x88 | 8 bits |
| section_syntax_indicator = 0 | 1 bit |
| DVB_reserved | 1 bit |
| ISO_reserved | 2 bits |
| EMM-U_section_length | 12 bits |
| unique_address_field | 40 bits |
| for (i=0; i<N; i++) { | |
| EMM_data_byte | 8 bits |

The unique_address_field parameter is a unique address of a card in a card EMM-U or the unique address of a decoder in a decoder EMM-U.

Messages intended for decoders denoted by a particular group of cards or directly for a particular group of decoders are EMM-S messages with the following structure:

| | |
|---|---|
| EMM-S_section( ){ | |
| table_id = 0x8E | 8 bits |
| section_syntax_indicator = 0 | 1 bit |
| DVB_reserved | 1 bit |
| ISO_reserved | 2 bits |
| EMM-S_section_length | 12 bits |
| shared_address_field | 24 bits |
| reserved | 6 bits |
| data_format | 1 bit |
| ADF_scrambling_flag | 1 bit |
| for (i=0; i<N; i++) { | |
| EMM_data_byte | 8 bits |

The shared_address_field parameter is the address of the group of cards in a card EMM-S or the address of the decoders group in a decoder EMM-S. The message concerns a decoder of a group or a card in a group if it is also explicitly denoted in an ADF field contained in EMM_data_byte, and that can be encrypted using the ADF_scrambling_flag information.

Messages intended for decoders designated by all cards or directly for all decoders are EMM-G messages with the following structure:

| | |
|---|---|
| EMM-G_section( ){ | |
| table_id = 0x8A or 0x8B | 8 bits |
| section_syntax_indicator = 0 | 1 bit |
| DVB_reserved | 1 bit |
| ISO_reserved | 2 bits |
| EMM-G_section_length | 12 bits |
| for (i=0; i<N; i++) { | |
| EMM_data_byte | 8 bits |

Content of EMM messages

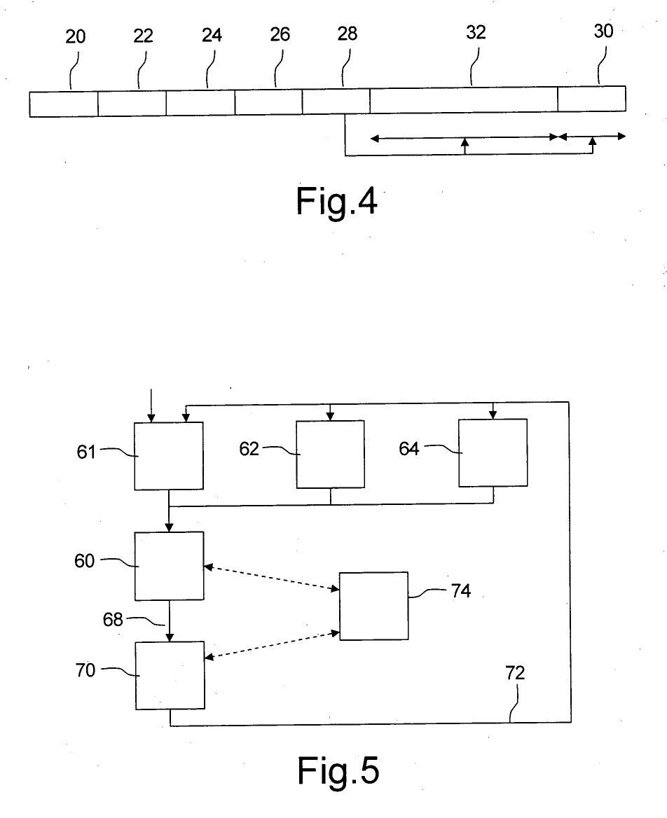

FIG. 4 diagrammatically shows the content of EMM_data_byte data in a matching EMM message. This content depends on the function to be executed by the decoder 2 for configuration or use of matching.

EMM_data_byte data include the following functional parameters:
ADF 20: address complement of a decoder in a group of decoders; this parameter is useful for addressing by group, otherwise it can be omitted; it can be encrypted,
SOID 22: identification of matching messages according to the invention, among other types of messages,
OPID/NID 24: identification of the group of decoders and the operator's signal,
TIME 26: time dating data for sending the message; this parameter is used to avoid the need to replay the message by the same decoder,
CRYPTO 28: identification of cryptographic protection functions applied to FUNCTIONS parameters 32.

FUNCTION parameters may be encrypted and protected by cryptographic redundancy 30.
FUNCTIONS 32: all parameters describing the configuration and use of matching.

The above functional parameters are freely organised in the EMM_data_byte data of an EMM message. One preferred implementation is the combination of these parameters by a T L V (Type Length Value) structure.

Processing of EMM Messages

The functional parameters described above will be processed by the decoder 2.

When they are transmitted in a decoder EMM, these parameters form the useful content of the EMM.

When they are transmitted in a card EMM, these parameters form a part of the useful content of the EMM that is clearly identifiable by the card, and that contains other parameters related to the card. This card then extracts functional parameters that concern it from the EMM and transmit them to the decoder 2. One preferred embodiment to enable this sort mechanism consists of integrating these functional parameters in an encapsulation parameter that cannot be processed by the card. Thus, when the card 6 detects this encapsulation, the card 6 sends a “Non-interpretable parameter (PNI)” type response to the decoder 2 accompanied by all parameters of the decoder 2.

The card 6 also receives a dated write data order through a card EMM, firstly to make sure that the card 6 has not already processed this message in another decoder, so as to avoid replay on another decoder, and secondly to limit processing of this EMM by a single decoder. Semantically, these data mean “Already processed”. One preferred embodiment of this anti-replay mechanism is to write these anti-replay data in a FAC (Facilities Data Block) data block of the card.

If the card responds “PNI” and “Already processed” after processing a matching EMM_card, the decoder 2 will ignore the parameters that it receives.

Configuration and Use of Matching

The complete set of all FUNCTIONS parameters 32 describes the configuration and use of matching according to the invention. This set of parameters is an arbitrary combination of the following functional parameters:
MODE: this parameter activates, deactivates or reinitialises the matching solution. After deactivation, the decoder does not check the identifier of a card inserted in the decoder, but it keeps the list of previously memorised identifiers and, after reinitialisation, the decoder does not check the identifier of an inserted card and no longer has any memorised card identifiers.
NBCA (Number of authorised cards): this parameter imposes the maximum number of card identifiers that a decoder is authorised to memorise; when it is not defined, NBCA is defined by implementation of the software module in the decoder according to the invention
LCA (List of authorised cards): this parameter imposes the list of card identifiers with which it can operate, to a decoder.
Disturbance: this parameter describes the disturbance to be applied by the decoder in the data access in the case of a card not matched with the decoder.

The above functional parameters are freely organised in all FUNCTIONS parameters 32. One preferred implementation is the combination of these parameters by a T L V (Type Length Value) structure.

Operation

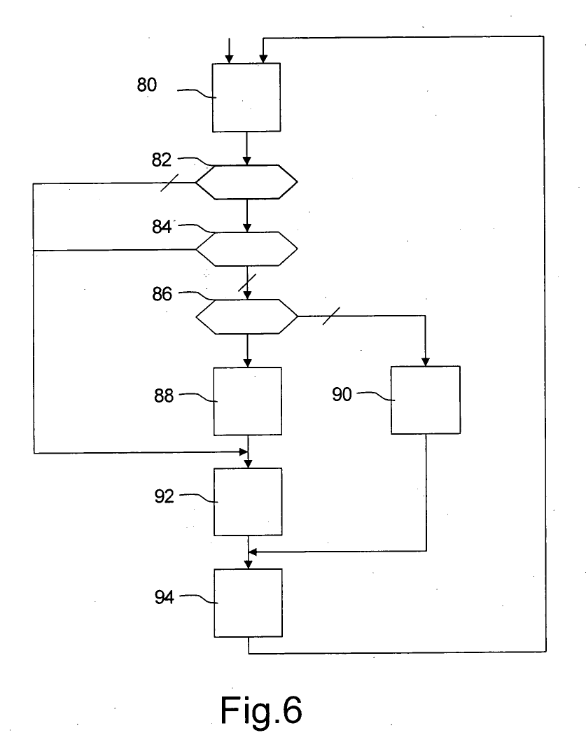

Operation of matching according to the invention will now be described with reference to FIGS. 5 and 6.

FIG. 5 is a functional diagram diagrammatically showing states of the matching function of the access control software 4 onboard a decoder 2.

The matching function is in the inactive state 60 when the access control software 4 has just been installed or downloaded (step 61), and when it has received a deactivate matching order (step 62) or reinitialise matching order (step 64) from the platform 1. In this state, the access control software 4 will operate with a card 6 inserted in the decoder 2 without verifying matching with this card.

In order to activate matching in a decoder 2, the operator defines a matching mode (=active) in the platform 1, optionally the maximum number NBCA of cards 6 that can be matched with the decoder 2 and the type of disturbance applicable in access to data in the case of a matching failure. As a function of this information, the platform 1 generates an EMM message and sends it (arrow 68), addressing the decoder(s) concerned and containing the configuration parameters. The matching function in the decoder changes to the active state 70.

The operator can deactivate matching in the decoder 2 through the platform 1 that generates an EMM message and sends it (arrow 72) addressing the decoder(s) concerned and containing a deactivation order without erasing the matching context 62 or a reset matching context order 64. The matching function in the decoder changes to the inactive state 60.

Regardless of the state of the matching function (inactive or active), it can receive (step 74) a list of authorised LCA cards by an EMM sent by the platform 1.

The matching function takes account of a card 6 in a decoder 2 as described in the flowchart in FIG. 6.

When a card 6 is inserted (step 80) into the decoder 2, the onboard access control software 4 in the decoder tests (step 82) if the matching function is in the active state 70.

If the matching function in the decoder is in the inactive state 60, the decoder will operate with the inserted card (step 92).

If the matching function in the decoder is in the active state 70, the access control software reads the identifier of the card and checks (step 84) if this identifier of the inserted card is already memorised in the decoder 2. If the identifier of this card 6 is already memorised in the decoder 2, the access control software 4 will operate with the inserted card (step 92). In this case, access to broadcast programs is then possible, subject to conformity with other access conditions attached to these programs.

If the identifier of this card 6 is not memorised in the decoder 2, the access control software checks (step 86) if the number of card identifiers 6 previously memorised is less than the maximum value NBCA of cards 6 authorised by the configuration.
If this number NBCA is reached, the access control software 4 refuses to operate with the card 6 inserted in the reader of decoder 2, and applies (step 90) the disturbance in the data access as defined by the operator. Such a disturbance may consist of blocking access to broadcast programs. It may be accompanied by a display on the screen of the terminal with which the decoder 2 is associated, to display a message asking the subscriber to insert another card 6 into the decoder 2,
If this number NBCA is not reached, the identifier of the card 6 inserted in the reader of the decoder 2 is added to the list of memorised identifiers (step 88). The access control software 4 then operates with the inserted card 6 (step 92).

When the card 6 is extracted (step 94) from the decoder 2, the access control software 4 starts waiting for a card 6 to be inserted (step 80).

The disturbance 90 in data access in the case of a matching fault may be of different natures, for example such as:
stop audio and video on encrypted channels (obtained by not submitting ECMs to the card to calculate CWs);
stop audio and video on plain text and analogue channels (obtained by a message to the middleware);
Send a message to the terminal middleware (example: Open TV message).

This disturbance may also be used to block stolen decoders.

In the case described in FIG. 2 in which the access control software 4 is executed in the removable interface 8 connected to a decoder 2, the logic controller described in FIG. 4 and the flowchart described in FIG. 5 are applicable directly to the onboard access control software 4 in this removable interface 8.

1. Method for matching digital data reception equipment (2) with a plurality of external security modules (6, 8) each with a unique identifier, method characterised in that it comprises the following steps:
connecting an external security module (6, 8) to the reception equipment,
memorising the unique identifier of the connected security module (6, 8) in the reception equipment (2), on the fly.

2. Method set forth in claim 1, characterised in that it also includes a check phase consisting of verifying whether or not the identifier of said module is memorised in reception equipment (2), every time that an external security module (6, 8) is connected to this reception equipment (2) later on.

3. Method set forth in claim 2, characterised in that it also comprises a step of transmitting a signal to the reception equipment (2) including at least one message to manage memorisation of the identifier of the external security module (6, 8) and/or a check phase management message.

4. Method set forth in claim 3, characterised in that said signal includes at least one of the following set values:
authorise memorisation,
prohibit memorisation,
erase identifiers previously memorised in the reception equipment (2),
activate or deactivating the check phase.

5. Method set forth in claim 3, characterised in that said signal also includes the maximum allowable number of memorised identifiers.

6. Method set forth in claim 3, characterised in that said signal includes a reconfiguration set value through which an updated list of identifiers of external security modules (6, 8) matched with the reception equipment (2) is transmitted to said reception equipment (2).

7. Method set forth in claim 6, characterised in that said list is transmitted directly to the reception equipment (2).

8. Method set forth in claim 6, characterised in that said list is transmitted through an external security module (6, 8) connected to said reception equipment (2).

9. Method set forth in claim 2, in which said check phase includes a procedure consisting of disturbing the data processing if the identifier of the connected external security module (6, 8) is not previously memorised in the reception equipment (2).

10. Method set forth in claim 1, characterised in that said data are distributed without encryption or scrambled by an encrypted control word and in that each external security module (6, 8) includes access rights to said data and a decryption algorithm for said control word.

11. Method set forth in one of claims 4 or 5, characterised in that said signal is transmitted to a reception equipment (2) in an EMM message specific to an external security module (6, 8) associated with this reception equipment (2).

12. Method set forth in one of claims 4 or 5, characterised in that said signal is transmitted to a reception equipment (2) in an EMM message specific to this reception equipment (2).

13. Method set forth in claim 6, characterised in that for a given reception equipment (2) said list is transmitted in an EMM message specific to a security module (6, 8) associated with this reception equipment (2).

14. Method set forth in claims 4 or 5, characterised in that said signal is transmitted to a group of reception equipment (2) in an EMM message specific to a group of external security modules (6, 8) associated with said reception equipment (2).

15. Method set forth in one of claims 4 or 5, characterised in that said signal is transmitted to a group of reception equipment (2) in an EMM message specific to said group of reception equipment (2).

16. Method set forth in claim 6, characterised in that for a given group of reception equipment (2), said list is transmitted in an EMM message specific to a group of external security modules (6, 8) associated with said reception equipment (2).

17. Method set forth in one of claims 4 or 5, characterised in that said check signal is transmitted in a private flow to a group of reception equipment (2).

18. Method set forth in claim 6, characterised in that for a given group of reception equipment (2), said list is transmitted in a private flow to each reception equipment (2).

19. Method set forth in one of claims 17 or 18, characterised in that said private flow is processed by a dedicated software executable in each reception equipment (2) as a function of the identifier of the external security module (6, 8) associated with it.

20. Method set forth in one of claims 11 to 16, characterised in that it also includes a mechanism that prevents the use of an EMM transmitted to the same security module (6, 8) in two distinct items of reception equipment (2).

21. Method set forth in one of claims 11 to 13, characterised in that said EMM are in the following format:

| | |
|---|---|
| EMM-U_section( ){ | |
| table_id = 0x88 | 8 bits |
| section_syntax_indicator = 0 | 1 bit |
| DVB_reserved | 1 bit |
| ISO_reserved | 2 bits |
| EMM-U_section_length | 12 bits |
| unique_adress_field | 40 bits |
| for (i=0; i<N; i++) { | |
| EMM_data_byte | 8 bits |

22. Method set forth in one of claims 14 to 16, characterised in that said EMM is specific to all external security modules (6, 8) or to all reception equipment (2) and are in the following format:

| | |
|---|---|
| EMM-G_section( ){ | |
| table_Id = 0x8A or 0x8B | 8 bits |
| section_syntax_indicator = 0 | 1 bit |
| DVB_reserved | 1 bit |
| ISO_reserved | 2 bits |
| EMM-G_section length | 12 bits |
| for (i=0; i<N; i++) { | |
| EMM_data_byte | 8 bits |

23. Method set forth in one of claims 14 to 16, characterised in that said EMM is specific to a sub-group of external security modules (6, 8) or reception equipment (2) and are in the following format:

| | |
|---|---|
| EMM-S_section( ){ | |
| table_id = 0x8E | 8 bits |
| section_syntax_indicator = 0 | 1 bit |
| DVB_reserved | 1 bit |
| ISO_reserved | 2 bits |
| EMM-S_section length | 12 bits |
| shared_address_field | 24 bits |
| reserved | 6 bits |
| data_format | 1 bit |
| ADF_scrambling_flag | 1 bit |
| for (i=0; i<N; i++) { | |
| EMM_data_byte | 8 bits |

24. Method set forth in claim 1, characterised in that identifiers of external security modules (6, 8) are grouped in an encrypted list.

25. Method set forth in any one of claims 1 to 24, characterised in that the reception equipment (2) includes a decoder and the external security module (6, 8) includes an access control card (6) in which information about access rights of a subscriber to digital data distributed by an operator is memorised, and in that matching is done between said decoder and said card (6).

26. Method set forth in any one of claims 1 to 24, characterised in that the reception equipment (2) includes a decoder and the external security module (6, 8) includes a removable security interface (8) provided with a non-volatile memory that can cooperate firstly with the decoder, and secondly with a plurality of conditional access control cards (6) to manage access to digital data distributed by an operator, and in that matching is done between said decoder and said removable security interface (8).

27. Method set forth in any one of claims 1 to 24, characterised in that the reception equipment (2) includes a decoder provided with a removable security interface (8) with a non-volatile memory that can cooperate firstly with said decoder, and secondly with a plurality of conditional access control cards (6), and in that matching is done between said removable security interface (8) and said access control cards (6).

28. Method set forth in claim 10, characterised in that the data are audiovisual programs.

29. Reception equipment (2) that can be matched with a plurality of external security modules (6, 8) to manage access to digital data distributed by an operator, characterised in that it includes means of memorising the identifier of each external security module (6, 8) connected to it, on the fly.

30. Equipment set forth in claim 29, characterised in that it comprises a decoder and in that the external security module (6, 8) is an access control card (6) containing information about access rights of a subscriber to said digital data, matching being done between said decoder and said card (6).

31. Equipment set forth in claim 29, characterised in that it includes a decoder and in that the external security module (6, 8) is a removable security interface (8) provided with a non-volatile memory and that is designed to cooperate firstly with said decoder, and secondly with a plurality of conditional access control cards (6), to manage access to said digital data, matching being done between said decoder and said removable security interface (8).

32. Equipment set forth in claim 29, characterised in that it includes a decoder provided with a removable security interface (8) with a non-volatile memory and that is designed to cooperate firstly with said decoder and secondly with a plurality of conditional access control cards (6) and in that matching is done between said removable security interface (8) and said access control cards (6).

33. Decoder that can cooperate with a plurality of external security modules (6, 8) to manage access to audiovisual programs distributed by an operator, each external security module (6, 8) having a unique identifier and including at least one data processing algorithm, decoder characterised in that it includes means of memorising the identifier of each external security module (6, 8) connected to it, on the fly.

34. Decoder set forth in claim 33, characterised in that said external security modules (6, 8) are access control cards (6) in which information about access rights of a subscriber to digital data distributed by an operator are stored.

35. Decoder set forth in claim 33, characterised in that said external security modules (6, 8) are removable security interfaces (8) including a non-volatile memory that can cooperate firstly with the decoder and secondly with a plurality of conditional access control cards (6) to manage access to digital data distributed by an operator.

36. Removable security interface (8) including a non-volatile memory and designed to cooperate firstly with a reception equipment (2), and secondly with a plurality of conditional access control cards (6), to manage access to digital data distributed by an operator, each card (6) having a unique identifier and containing information about access rights of a subscriber to said digital data, interface characterised in that it includes means of recording the identifier of each access control card (6) in said non-volatile memory, on the fly.

37. Interface set forth in claim 36, characterised in that it consists of a PCMCIA card on which digital data descrambling software is installed.

38. Interface set forth in claim 36, characterised in that it consists of a software module.

39. Executable computer program in a reception equipment (2) that can cooperate with a plurality of external security modules (6, 8) each having a unique identifier and in which information about access rights of a subscriber to digital data distributed by an operator are stored, characterised in that it includes instructions to memorise the identifier of each external security module (6, 8) connected to said reception equipment (2), on the fly.

40. Computer program set forth in claim 39, characterised in that it also includes instructions to locally generate matching control parameters of the reception equipment (2) with an external security module (6, 8) as a function of a signal transmitted to said reception equipment (2) by the operator.

41. Computer program set forth in claim 39, characterised in that it also includes instructions intended to check if the identifier of said external security module (6, 8) is memorised in the reception equipment (2), at each later use of an external security module (6, 8) with the reception equipment (2).

42. System including a plurality of reception equipment (2) connected to a data and/or services broadcasting network, each reception equipment (2) being capable of being matched with a plurality of external security modules (6, 8), said system also including a commercial management platform (1) communicating with the reception equipment (2) and with said external security modules (6, 8) characterised in that it also includes:
a first module arranged in said commercial management platform (1) and that will generate matching queries,
and a second security module arranged in said reception equipment (2) that will process said queries to prepare a matching configuration and to control matching.
